(19) United States
(12) Patent Application Publication
(10) Pub. No.: US 2005/0168749 A1
(43) Pub. Date: Aug. 4, 2005

(54) Optical olfactory sensor with holographic readout

(76) Inventors: Hongke Ye, Baltimore, MD (US); Oyvind Nilsen, Boulder, CO (US); Dana Z. Anderson, Boulder, CO (US); Victor M. Bright, Boulder, CO (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/517,165

(22) PCT Filed: Jul. 2, 2003
(86) PCT No.: PCT/US03/21228

Related U.S. Application Data
(60) Provisional application No. 60/394,490, filed on Jul. 8, 2002.

(51) Int. Cl. G01B 9/021

(52) U.S. Cl. 356/458

(57) ABSTRACT

This invention relates to optical detection of vapors, in particular devices and methods for detection of vapor concentration and changes in vapor concentration using dynamic holography. The devices and methods employ a transducer which absorbs the vapor to be tested, thereby leading to a change in the transducer. The changes in the transducer cause a change in the optical path length of an image beam which is interacted with the transducer. Dynamic holography allows determination of the change in the dimensions and index of refraction of the transducer, and thus the change in the concentration of the vapor to be tested. The devices and methods of the invention are capable of testing a plurality of vapors by using a transducer array.

### CROSS-REFERENCE TO RELATED APPLICATIONS

This application claims the benefit of U.S. Provisional Application No. 60/394,490 filed Jul. 8, 2002, which is hereby incorporated by reference in its entirety to the extent not inconsistent with the disclosure herewith.

### BACKGROUND OF THE INVENTION

This invention relates to optical detection of vapors, in particular devices and methods for detection of vapor concentration and changes in vapor concentration using dynamic holography.

Vapor detection devices exist in a variety of forms. One form of vapor detection device employs a transducer to detect changes induced by the vapor, rather than analyzing the vapor directly. The transducer may be highly selective towards an individual vapor (“lock and key” approach). Alternatively, the transducer may respond to several vapors and an array of different transducers may be used to produce a “signature” which is used to classify, and in some cases quantify the vapor of concern (Severin et al. (2000), Anal. Chem. 72, 658-668). Vapor detection devices employing transducers have a variety of commercial, industrial and military applications.

In particular, vapor detection devices employing transducers have been used for olfactory sensors, also known as artificial or electronic noses. An artificial nose typically contains an array of dissimilar transducers simulating the human olfactory response (Nagle, H. et al., (September 1998), IEEE Spectrum, 22-34). Olfactory sensors have used surface acoustic wave (SAW), electrochemical, conducting polymer, piezoelectric, and optical methods for generating and detecting the transducer response (White et al., (1996), Anal. Chem. 66, 2191-2202). SAW arrays have been limited in size because of the electronic complexity involved and the challenges associated with micromanufacturing large numbers of such systems into an integrated system (Lonergan et al., (1996), Chem. Mater. 8, 2298-2312).

Many optical transducer-based vapor detection devices employ optical fibers or other media for transmission of light through total internal reflection (e.g. capillary tubes). These devices have been configured in a variety of ways. For example, in intrinsic optical fiber sensors a change in the optical fiber itself occurs, while in extrinsic sensors the optical fiber serves as a conduit to transport light to and from the sensing element (Sietz., W. (1988), CRC Crit. Rev. Anal. Chem., 19 (2), 135-173).

Fiber-optic sensors often consist of an analyte sensing element deposited at the distal end of an optical fiber, with the optical sensing element typically composed of a reagent phase immobilized at the fiber tip by either physical entrapment or chemical binding. This reagent phase usually contains a chemical indicator that experiences some change in optical properties upon interaction with the analyte (White et al., (1996), supra). Fluorescent dyes have been used as chemical indicators (White et al., (1996), supra; Oreliana, G. et al. (1995), 67, 2231-2238). A sensor or transducer array is made by using multiple fibers.

Interferometric fiber-optic sensors have also been constructed which effectively provide a single transducer or sensing element rather than an array of transducers. The optical fiber is used to construct a reference branch and a measuring branch of an interferometer. The measuring branch contains a sensing element which interacts with the measuring branch, causing its optical properties to change so that there is a shift in the phase of the transmitted light. When the light from the two branches is recombined, interference results (Sietz, W. (1988), supra). One interference sensor to measure the partial pressure of hydrogen used a coating of palladium on the outside of the optical fiber for a transducer. The higher the partial pressure of hydrogen, the more was adsorbed in the palladium. This constricted the fiber and modified the phase of light transmitted through the fiber (Butler, M. (1984), Appl. Phys. Lett., 45(10), 1007-1009). Another interference sensor (Vali et al., U.S. Pat. No. 5,004,914, issued Apr. 2, 1991) bonded the reference branch and measuring branch optical fibers to magnetorestrictive substrates. The measuring branch substrate was coated to facilitate collection of the vapor molecules. The frequency of oscillation of the measuring branch substrate changed slightly in response to the collection thereon of molecules of the chemical vapor to be detected, allowing a difference in resonant frequency between the reference and sensor substrates to be detected.

### BRIEF SUMMARY OF THE INVENTION

The present invention provides interferometric vapor detection devices with a holographic readout which can be used as olfactory sensors. Embodiments of the devices have the following advantages: easily manufactured transducer array, versatile response, repeatable response, fast response (within 5 seconds), and high sensitivity. The sensitivity of the devices depends upon the transducer material, but a sensitivity has been attained for ethanol vapor of approximately 60 ppb mm²/sqrt(Hz).

Embodiments of the invention also provide methods for detection of vapor concentration and changes in vapor concentration using dynamic holography. The methods analyze a dynamic signal rather than a DC (steady state) signal. As a result, the methods are insensitive to slowly varying environmental parameters. Furthermore, the signal to noise ratio of the dynamic signal can be improved via filtering over an equivalent DC signal.

Additional embodiments of the invention provide devices and methods for optical detection of changes in vapor concentration using dynamic holography. The vapor being detected is termed a “test” vapor. The methods of the invention can detect a change from an undetectable test vapor level to a detectable test vapor level or from one detectable test vapor level to another. The methods are also capable of simultaneously detecting changes in concentration for multiple test vapors.

The methods of the invention can utilize a transducer capable of absorbing the test vapor. Changes in test vapor concentration can cause changes in the transducer's dimensions, changes in the transducer's index of refraction and/or other changes that can be detected optically using dynamic holography. Multiple transducers, each of which responds to a different test vapor, can be used simultaneously to detect changes in concentration for multiple test vapors.

The changes in the transducer are detected optically. In particular, the transducer is placed in the path of a beam of coherent light, which is referred to as the image beam. After the image beam interacts with the sample, it is used to generate an interference pattern. Changes in the dimensions and the index of refraction of the transducer cause changes in the optical path length and the intensity of the beam and thus changes in the interference pattern. The amount of change in the optical path length of the beam indicates the amount of change in test vapor concentration.

As used herein, dynamic holography involves generation of an interference pattern, generation of a hologram based on the interference pattern using a dynamic holographic medium, and reading out the hologram generated. Dynamic holography is used to provide a holographic readout based on the interference pattern and thereby determine the change in dimensions and index of refraction of the transducer. The holographic readout provides real-time information about changes in vapor concentration.

As defined herein, a hologram is a record of the interference pattern between two or more electromagnetic waves embodied by the spatial variation of the dielectric constant, or index-of-refraction, of a medium or media. “Dynamic holography” is holography that involves either a dynamic holographic medium (or media) or involves an apparatus, electronic or otherwise, that replicates the functionality of a dynamic holographic medium (or media) (e.g. digital holography). A “dynamic holographic medium” is a medium that is capable of performing holographic recording or readout nearly simultaneously on a nearly continual basis without substantial depletion or degradation of its holographic properties over times of interest. “Holographic recording” is the process of producing a hologram using the interference of electromagnetic waves to itself lead to the index-of-refraction or dielectric constant variation in a recording medium (even if the recording medium requires additional elements and/or processing to effect the index-of-refraction or dielectric constant variation). For non-digital holography, “holographic readout” or “reading out the hologram” is scattering of an electromagnetic wave from a hologram (usually in such a way as to reproduce a version of one or more of the original recording waves). For example, holographic readout of a hologram can be used to reproduce a version of the original image wave. The term “holographic readout” can also be used as a noun referring to the result of scattering of an electromagnetic wave from a hologram (for example, the reproduced version of the original image wave). For digital holography, “reading out” the hologram can involve reading out the interference pattern information from a spatial information recording device and processing the information recorded.

Embodiments of the invention also provide a method for determining the concentration of a test vapor that is not necessarily changing. In this method, a reference vapor and the test vapor can be alternately supplied to the transducer, creating a change in the vapor environment seen by the transducer, which can be detected and analyzed using the methods described above.

Embodiments of the invention also provides a method for the detection of a change in concentration of a test absorbant in a liquid environment comprising the steps of: providing a transducer capable of absorbing the test absorbant and thereby changing the transducer; exposing the transducer to the test absorbant; and detecting the change in the transducer using dynamic holography, thereby detecting the change in concentration of the absorbant. The change in the test absorbant concentration can cause changes in the transducer's dimensions, the transducer's index of refraction and/or other changes that can be detected optically using dynamic holography.

The devices of the invention can employ one or more of the methods of the invention. The devices preferably have a real time response, with measurements being typically completed in less than 5 seconds and preferably in less than 2 seconds. The devices can be operated with battery power and can be made portable. By a portable device, it is meant that the device is suitcase-sized, briefcase sized, or smaller. The devices of the invention have commercial, industrial, medical, law enforcement and military applications. These applications include detecting leaks in an industrial environment, monitoring a manufacturing process vapor environment (including pharmaceutical and cosmetics processes), vapor recognition and tracking, and detecting biohazards, automobile emissions, chemical vapors associated with explosives, alcohol, controlled substances, spoiled perishable products, and toxic gases, to name a few.

In one embodiment, the devices of the invention are based on an optical novelty filter which incorporates a photorefractive element. A “novelty filter” shows what is new in an input image compared with the input's recent history (Anderson and Feinberg, (1989), IEEE J. Quantum Electron., 25(3) 635-640, hereby incorporated by reference). Because devices based on novelty filters detect relatively rapid changes, the devices are insensitive to slowly varying environmental parameters like temperature, pressure and humidity. The novelty-filter based devices are also self-adaptive to distortions in wave fronts and drifts in optical path.

Embodiments of the invention provide an olfactory sensor system with a holographic readout employing an optical novelty filter. This sensor system produces a change in the intensity of the transducer image at a detector when the test vapor concentration changes. In a two beam coupling device, a reference beam and an image beam are combined within a photorefractive element such as a photorefractive crystal, thus creating a hologram in the element. The output from the photorefractive element in the direction of the image beam consists of the image beam and a diffracted portion of the reference beam (the diffracted portion of the reference beam can be regarded as part of the holographic readout). At steady state, the diffracted portion of the reference beam interferes with the image beam to produce an intensity pattern at a detector placed after the photorefractive element in the path of the image beam. If the vapor concentration and path length of the image beam change suddenly, the phase difference between the image beam and the reference beam changes and the intensity of the transducer image at the detector changes. Holographic optical novelty filter versions other than the two-beam coupling version described here can also be used, including those that do not require an externally-supplied reference beam, such as those that make use of beam-fanning (amplified spontaneous scattering), and those that use self-pumped phase-conjugation (Anderson and Feinberg, (1989), supra and Ford et al., (1988), Optics Letters, 13(10), 856-858, hereby incorporated by reference).

### BRIEF DESCRIPTION OF THE DRAWINGS

FIG. 1 is a schematic of a two-beam olfactory sensor system.

FIG. 2 schematically illustrates the diffraction of the reference beam by the internal refraction index grating generated by the photorefractive element.

FIG. 3 schematically illustrates the response of four transducers on a substrate, two sensitive to methane and two sensitive to hexane, to a sudden increase in methane concentration.

FIG. 4 shows the relationship between the detector reading and concentration for ethanol vapor during calibration of a two-beam coupled sensor system.

FIGS. 5A-5C show the response pattern to ethanol (5A), the response pattern to hexane (5B), and the response pattern to a mixture of ethanol and hexane (5C) of a 2 by 2 transducer array.

FIG. 6 shows the response of a sensor system to changes in concentration of the vapor environment.

FIG. 7 shows the relation between the sensor system sensitivity and the active area of the transducer material.

FIG. 8 shows the relationship between the detector reading and concentration for ethanol vapor for a two-beam sensor system using phase modulation.

### DETAILED DESCRIPTION OF THE INVENTION

Embodiments of the invention provide an olfactory sensor system for detecting changes in test vapor concentration in an environment. In one embodiment, the sensor system comprises a coherent light source capable of producing a beam of light, a transducer in fluid communication with the environment and capable of responding to a change in test vapor concentration, a dynamic holographic medium, and a detector, wherein at least part of the beam of light passes from the light source to the transducer, from the transducer to the dynamic holographic medium, and from the dynamic holographic medium to the detector.

Depending on the desired sensor system configuration, the sensor system can additionally comprise a variety of elements. For example, a beam splitter can be used to generate a reference beam and an image beam which are recombined in the photorefractive element as in a two-beam coupling novelty filter. As is known by those skilled in the art, alternative novelty filter configurations are available which do not require that the beam be split (Anderson and Feinberg, (1989), supra; Ford et al. (1998) supra). Beam directing elements such as mirrors and prisms can also be placed in the beam path. Beam shaping elements such as lenses, curved mirrors, filters, apertures, line generators, and static holographic elements can be used to change the beam diameter and/or to change the beam shape and/or tailor its intensity. Lenses can also be used for beam imaging. As is known by those skilled in the art, the need for beam directing and shaping elements depends upon the particular sensor system configuration and different beam directing and beam shaping elements can be substituted for one another. Polarization modifying elements such as polarizers and half wave plates can be used to adjust the polarization of a beam so that it is optimal for a particular orientation of photorefractive element, as well as to produce a variable beam splitter. The transducer may be supported on a substrate and a vapor feeding system can be used to control the vapor environment in fluid communication with the transducer. Control systems can be used to control the sampling rate of the detector and the output from the detector can be fed to an analysis system for further processing.

In one configuration, transducer material can be applied to the outside of an optical fiber, either on one end or along the length of a portion of a fiber where the fiber core is sufficiently close to the surface that an evanescent field is present in the transducer material. Several such fibers can be used with different transducer materials for chemical vapor sensing diversity. In such a case, the output of the fiber or fibers collectively serves as the image beam.

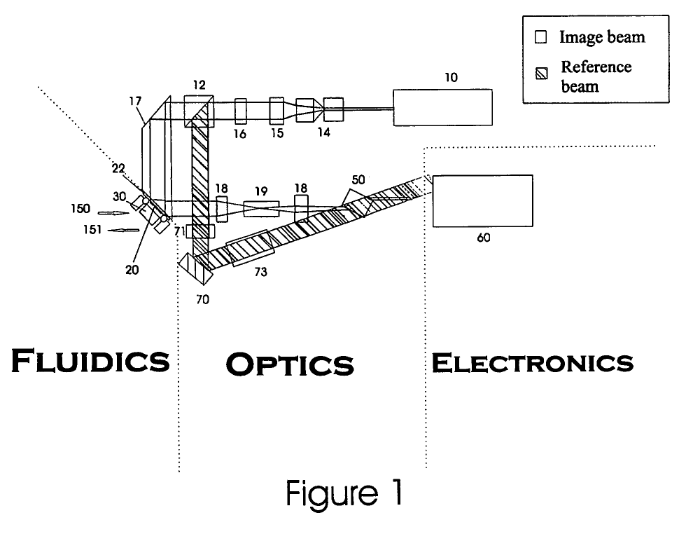

FIG. 1 shows a two-beam coupling system in which the beam from coherent light source (10) is split by beam splitter (12) into an image beam (unshaded beam in FIG. 1) and a reference beam (shaded beam in FIG. 1). Beam-shaping elements (14-16), shown as lenses, increase the beam diameter and change the beam shape. Beam-directing element (17), shown as a prism, is used to direct the image beam towards transducer (20). Transducer (20) is shown attached to substrate (22). Vapor feeding system (30) controls the environment to which the transducer (20) is exposed. Labels 150 and 151, respectively, indicate vapor being fed into and out of vapor feeding system (30). If beam-directing element (17) is a prism, preferably the index of refraction of substrate (22) and prism (17) are matched and a layer of index-matching fluid (not shown) is placed at the substrate-prism interface. At least part of the image beam interacts by reflection and/or transmission, and/or evanescently with the transducer then travels from the transducer to the photorefractive element (50). Optional lens(es) (18) keeps the image beam within the photorefractive element (50) to optimize the dynamic holographic performance. Optional polarizer (19), shown in the path of the image beam is used to align the polarization of the image beam with the optical axis of the photorefractive element. At least part of the image beam entering the photorefractive element passes through the element as shown (and typically another portion will diffract) and travels to detector (60).

The reference beam is directed to photorefractive element (50) by beam directing element (70), shown as a mirror. An optional half wave plate (71) and polarizer (73) are used to align the polarization of the reference beam with the optical axis of the photorefractive element. Alternatively one can cut and orient a photorefractive crystal as desired. Typically the reference beam enters photorefractive element (50) at an angle with respect to the image beam. Within the photorefractive element, at least part of the reference beam is diffracted in the direction of the image beam and so passes to detector (60).

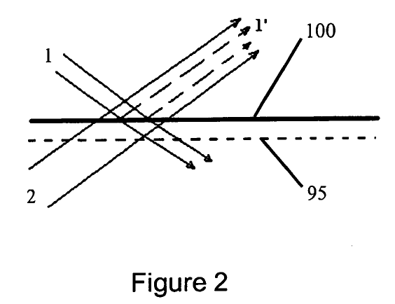

FIG. 2 schematically illustrates the diffraction of the reference beam (beam 1) by the internal refraction index grating (100) generated by the photorefractive element. In FIG. 2, the diffracted reference beam is beam 1′ and the image beam is beam 2. The interference pattern (95) between beams 1 and 2 is also illustrated. For some photorefractive materials at steady state, the portion of the reference beam diffracted in the direction of the image beam is π (180°) out of phase with the image beam and destructively interferes with the image beam, producing a low (or null) intensity image of the transducer at the detector. The generated grating has a π (180°) phase shift from the interference pattern. In other materials the reference beam diffracts with a different steady-state phase. In any case, some pattern of intensity is produced at the detector in steady-state. If the transducer responds to a sudden change in chemical vapor environment, the optical path length experienced by the image beam will change. Until the photorefractive element adapts to the change in optical path length of the image beam, the phase difference between the image beam and the reference beam will no longer be its steady-state value and the transducer image at the detector will be changed in intensity over the steady state transducer image. Analysis of the information from the detector allows determination of the change in dimensions and index of refraction of the transducer.

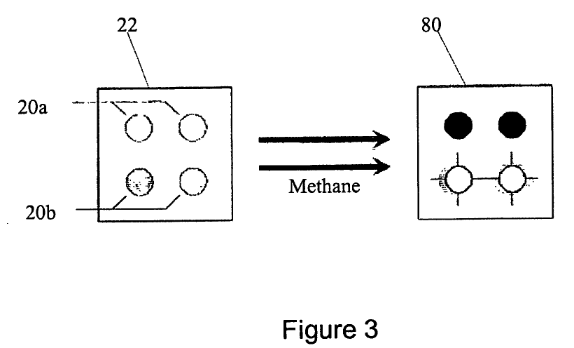

FIG. 3 schematically illustrates the response of four transducers (20a and 20b) on a substrate (22), two sensitive to methane (20b) and two sensitive to hexane (20a), to a sudden increase in methane concentration. In the output image (80) the two transducers sensitive to methane become bright while the two transducers sensitive to hexane remain dark.

The transducer (20) is capable of responding to a change in test vapor concentration by absorbing the vapor and producing an optically detectable change. For example, the change in transducer dimensions can lead to a change in optical path length, while the change in index of refraction can lead to a change in both optical path length and beam intensity. The desired transducer area depends upon the sensitivity required, with larger transducer areas giving higher sensitivity. A transducer may be supported on one or more substrates. For configurations where the image beam passes through the substrate before reaching the transducer, the substrate is selected so that it does not significantly absorb the image beam and so that it does not respond to the test vapor. In the configuration shown in FIG. 1, the substrate is selected to have an index of refraction close to that of the prism (for example, a glass slide). Adhesive materials may be used to join transducers to a substrate or to join substrates to one another.

Films of material are preferred for use as transducers. Polymer films are suitable for use as transducers, although other inorganic and organic materials, including biomaterials such as proteins and enzymes, can be used. The polymer film can be doped with another material, such as a metal, to increase the sensitivity of the transducer. In one mode of operation, each transducer material is selected so that it interacts/absorbs with only a specific variety of vapors. This allows fabrication of an array of transducer elements on a substrate, with different transducers being used to absorb different test vapors. The number of transducers selected is determined by the application, but arrays of 25, 50, 75, 100 or more transducers can be fabricated.

For polymer transducers, the solubility of test vapors in various polymers differs greatly. Therefore, it is preferable to use polymeric materials that exhibit maximum response to the vapor(s) to be detected. Polymers known to the art of vapor sensors include, without limitation, poly(N-vinylpyrrolidone); poly(ethylene-co-vinyl acetate); poly(4-vinylphenol); poly(styrene-co-allyl alcohol); poly(α-methylstyrene); poly(vinyl chloride-co-vinyl acetate); poly(vinyl acetate); poly(methyl vinyl ether-co-maleic anhydride); poly(bisphenol A-carbonate); poly(styrene); poly(styrene-co-maleic anhydride); poly(vinyl butyral); poly(sulfone); poly(methyl methacrylate); poly(vinylidene chloride-co-acrylonitrile); poly(caprolactone); poly(ethylene-co-vinyl acetate); poly(ethylene oxide); poly(butadiene); poly(epichlorohydrin); poly(styrene-co-butadiene); addition product of sodium menthoxide to poly(pentafluorostyrene); (+)-isopinocampheol-derivatized poly(p-chloromethylstyrene); poly(fluorostyrene); and poly(styrene-co-isoprene) (Severin et al. (2000), supra).

For polymer film transducers, the film thicknesses are typically on the order of 0.05 to 100 microns. The desired film thickness depends upon the extent to which the film absorbs the image beam.

For polymer film transducers deposited on a substrate, transducer characteristics that can vary and affect the measurements are: index-of-refraction, thickness, surface roughness, area, porosity, and transducer-to-substrate bonding. Methods for depositing polymer film deposits on a substrate include dissolving the pulverized polymer with a suitable solvent and either manually depositing the solution on the substrate or using an inkjet printer. A grid of photoresist fabricated via photolithography on the substrate prior to deposition can be used to constrain the polymer solution and produce manually deposited transducers of more uniform area. Commercially available print heads can also be used if the solvent is compatible with the print head materials. A polymer transducer may also be formed on a substrate by depositing polymer solution on a Mylar® or Teflon® sheet, curing the polymer solution on the sheet, cutting the cured polymer and sheet to the desired transducer dimensions, and joining the sheet side of the polymer-sheet assembly to the substrate with an adhesive such as UV cured cement. However the polymer solution is deposited, the film can be cured in a sealed chamber in an atmosphere saturated with the solvent in order to improve the uniformity of the film thickness. Other methods known to the art for depositing polymer films may also be employed.

A vapor feeding system can be used to control the vapor environment in fluid communication with the transducer. The vapor feeding system can isolate the transducer environment from the environment surrounding other elements of the sensor system by using a controlled environment “chamber” surrounding the transducer(s). The “chamber” can seal to the transducer substrate with an o-ring or by other means known to those skilled in the art.

One or more gas lines can be used to introduce pulses, “sniffs” or “breaths” of vapor into the “chamber.” The test vapor may be supplied to the transducer either continuously or in “sniffs.” The vapor feeding system may also deliver a test vapor and a reference vapor to the transducer alternately. As used herein, a “reference vapor” is a vapor selected for use in the measurement which may be the same or different from the vapor to be tested or analyzed. A reference vapor may be a vapor which does not induce polymer swelling such as noble gases or gases such as N₂, H₂, O₂ or CO₂. A reference vapor can also be a vapor that is to be compared with a test vapor. In a perfume factory, for example, the reference vapor may be the standard perfume odor. The reference vapor can also be a vapor collected from the recent history of the environment or a vapor taken from another spatial region in the vicinity of the test vapor (for example, a test vapor passageway could be placed near the opening of a beaker while the reference vapor passageway could be placed further away from the opening). A number of standard reference vapors can also be used and the vapor in question tested against every one of the reference vapors. An electrically, pneumatically or manually actuated valve can be used to alternately deliver the test and reference vapors at a regular selected frequency. Typical exposure cycles can range from 100 ms to 2 s. Alternatively, the test and reference vapors can be alternated without using a valve by using syringes or by other means known to those skilled in the art.

A photorefractive element can be any photorefractive material suitable for use with the devices and methods of invention. As used herein, a photorefractive material is a material which has an index of refraction which depends on the applied electric field. The photoelectric effect is described, for example, by Glass (A. M. Glass, (1978) Optical Engineering, Vol. 17, p.470). Suitable photorefractive materials include photorefractive crystals. Photorefractive crystals preferred for two-beam coupling devices include barium titanate, lithium niobate, strontium barium niobate (SBN) and several others known to those skilled in the art of photorefractive materials and devices. It is preferred that the coupling strength (Γ) times the length of the medium (L) is higher than about 1, and more preferred that it is on the order of 10 or so.

In the configuration shown in FIG. 1, the detector is placed on the path of the image-carrying beam after the photorefractive crystal. To use multiple detectors, the beam may be split or the detectors may be arranged in an array which mimics the array of transducers. A charge-coupled device (CCD) camera, which acts as many detectors, or other non-CCD imaging array sensitive to the light beam can be used to record the response pattern. In the two-beam coupling sensor system described above, the camera will only detect the light from activated polymer spots. A photodiode can be used to detect the beam intensity.

A control system can be used to synchronize the detector with the vapor feeding system to increase the sensitivity of the sensor system. For a vapor feeding system which uses an electrical switch to alternate between a test vapor and a reference vapor at a particular frequency, the control system can synchronize the sampling rate of the detector with the signal that drives the switch. In each “sniff” cycle from reference vapor to test vapor to reference vapor, the expected system response frequency is twice that of the cycle frequency. A lock-in amplifier can be used to lock in the sampling rate to the second harmonic of the “sniffing” and to set a phase shift to allow some delay for vapor flow, vapor diffusion, and the response of the photorefractive crystal. This procedure can help improve the signal-to-noise ratio of small vapor-induced signals.

Holographic optical novelty filter versions other than the two-beam coupling version shown in FIG. I and described herein can also be used, including those that do not require an externally-supplied reference beam. Two examples are those that make use of beam-fanning (amplified spontaneous scattering), and those that use self-pumped phase-conjugation (Anderson and Feinberg, 1989, supra).

Embodiments of the invention also provide a method for the detection of a change in concentration of a test vapor in an environment comprising the steps of: providing a transducer capable of absorbing the test vapor and thereby changing the transducer; exposing the transducer to the test vapor; and detecting the change in the transducer using dynamic holography, thereby detecting the change in concentration of the vapor. As used herein, “detecting the change in the transducer using dynamic holography” involves generating an interference pattern which contains information about the change in the transducer, generating a holograph based on the interference pattern using a dynamic holographic medium or an apparatus that replicates the functionality of a dynamic holographic medium, and reading out the hologram generated.

The change in the transducer can be detected in several ways. In the two-beam coupling method described above, the coherent light source produces a source beam which is split into an image beam and a reference beam. The image beam interacts with the transducer. A hologram based on the interference of the image and a reference beam is then generated within the photorefractive element. The hologram contains information about the change in the transducer, and thus the change in test vapor concentration. Reading out the hologram results in an interference pattern between the image beam and a portion of the holographic readout at a detector as has been described above. The interference pattern measured at the detector can be used to determine the change in the transducer and thus the change in test vapor concentration.

In another mode of operation, the source beam acts as a first image beam since no reference beam is split off prior to interaction of the source beam with the transducer. Instead, the first image beam is split after it interacts with the transducer into a second image beam and a third image beam. The second and third image beams interact to produce a hologram using either a photorefractive element or digital holography. The hologram can be read out to determine the change in test vapor concentration.

In yet another mode of operation, the source beam again acts as an image beam since no reference beam is split off. After the image beam interacts with the transducer, it is used to create a hologram inside a photorefractive element. In this case, the hologram is based on the interaction of the image beam and amplified scattered light from the image beam (photorefractive fanout). The hologram can be read out to determine the change in test vapor concentration.

More generally, the methods and devices of the invention can employ a dynamic holographic medium. As used herein, dynamic holographic media include photorefractive materials and equivalent media with which one can nearly simultaneously perform real-time dynamic holography, but which do not undergo the specific physical mechanisms associated with the photoelectric effect. These media include photosensitive thermoplastic films and other photosensitive media.

Alternatively, the photorefractive element or equivalent medium can be eliminated and the hologram created using digital holography. When digital holography is employed, the interference pattern is recorded on a spatial recording device, such as a CCD camera, photodiode array, or complementary metal-oxide semiconductor (CMOS) camera. An information processing device, such as a computer or microporcessor can be used to process the spatial information recorded. In an embodiment of an olfactory sensor system using digital holography, the dynamic holographic medium and the detector in optical communication with the dynamic holographic medium are replaced by a spatial recording device and an information processing device. Digital holography techniques are known to those skilled in the art.

In the methods of the invention which employ a reference beam and an image beam, the reference beam or the image beam can be phase modulated to introduce an extra periodic relative phase variation between the reference beam and the image beam. Phase modulation can also be used in a setup where no reference beam is present and the image beam is split after it interacts with the transducer (Beam-fanning novelty filter with enhanced dynamic phase resolution), H. Rehn et al., (1995) Applied Optics-OT, Vol.34 No.2, p.4907) Phase modulation can increase the signal to noise ratio of the detector signal. Phase modulation is a technique known to the art, and is described, for example by Rehn et al. (1995). In the experimental two-beam setup shown in FIG. 1, phase modulation can be accomplished by attaching a piezoelectric device to mirror (70) to translate the mirror and thereby impose a periodic phase variation on the reference beam. In a two-beam setup, the phase modulator can be placed on either beam and can be located anywhere after the beam splitter and before the photorefractive element or equivalent. In a single-beam setup, the phase modulator can be located anywhere after the light source and before the photorefractive element or equivalent. Other methods of performing phase modulation and phase modulators known to the art, for example, using an elecro-optic modulator (EOM) can be used. Sine waves, square waves and other periodic functions may be used in the phase modulation methods of the present invention. Methods of the invention employing phase modulation are capable of detection at parts per billion levels.

Embodiments of the invention also provide a method for determining the concentration of a test vapor which is not necessarily changing. In this method, a reference vapor is alternately supplied with the vapor to be tested. The change between the reference vapor and the test vapor creates a change in the vapor environment seen by the transducer, which can be detected using the methods described above. The changes can be quantified and correlated to vapor concentration by means known in the art.

Embodiments of the invention further provide a method for detection of a change in concentration of a plurality of test vapors in an environment comprising the steps of: providing a plurality of transducers each capable of absorbing a test vapor and thereby changing the transducer, wherein the transducers are selected so that at least one separate transducer absorbs each of the test vapors; and detecting the change in the transducers using dynamic holography, and analyzing this change, thereby detecting the change in concentration of the test vapors.

Embodiments of the invention also provide a method for the detection of a change in concentration of a test absorbent in a liquid environment comprising the steps of: providing a transducer capable of absorbing the test absorbant and thereby changing the transducer; exposing the transducer to the test absorbant; and detecting the change in the transducer using dynamic holography, thereby detecting the change in concentration of the absorbant. The change in the test absorbant concentration can cause changes in the transducer's dimensions, the transducer's index of refraction and/or other changes that can be detected optically using dynamic holography.

In the methods of the invention, the change in the transducer upon exposure to the test vapor or test absorbant may be any change that can be detected optically using dynamic holography. For example, the transducer may undergo a change in its dimensions and/or index of refraction.

### EXAMPLE 1

### Fabrication of Transducer Arrays

Calibration Array

An array of 16 poly(N-vinylpyrrolidone) transducers, which absorb water and ethanol, was fabricated on a single glass slide. The transducers were fabricated using a syringe to manually deposit the polymer solution on the slide. Water was used as the solvent. The diameter of each circular transducer was approximately 0.4 mm, which was read from the image displayed on the CCD camera.

2 by 2 Array

A 2 by 2 transducer array with two types of polymers, poly(N-vinylpyrrolidone) and poly(ethylene-co-vinyl acetate) was fabricated on a single glass slide. Two transducers were fabricated of poly(N-vinylpyrrolidone), which absorbs water and ethanol, and two were fabricated of poly(ethylene-co-vinyl acetate), which absorbs hexane. The transducers were fabricated using a syringe to manually deposit the polymer solution on the slide. Epoxy ethanol was used as the solvent for poly(N-vinylpyrrolidone) while toluene was used as the solvent for poly(ethylene-co-vinyl acetate). The diameter of each circular transducer was approximately 0.7 mm.

### EXAMPLE 2

### Two-Beam Coupled Sensor System

A two-beam coupled sensor system similar to that shown in FIG. 1 has been constructed and its operation demonstrated. The system was approximately 14 cm×11 cm. The coherent light source was a solid state double frequency laser with 532 nm selected as the operating wavelength (Crystal Laser). This laser had a power of 75 mW and an initial beam diameter of about 0.8-1.5 mm. Beam shaping elements were used to expand the beam to a 5 mm by 5 mm square beam. The transducers were fabricated on glass slides as described above. The system as described is capable of analyzing a transducer array of greater than 16 elements and should be capable of analyzing a transducer array of 100 elements. The vapor feeding system isolated the transducer environment from the environment surrounding other elements of the sensor system by using a controlled environment “chamber” surrounding the transducer(s). An electric valve alternately delivered pulses of a test vapor and a reference vapor into the “chamber” at a “sniff” cycle frequency of approximately 1.75 Hz. The photorefractive element was a barium titanate crystal with a coupling constant (Γ) *L of approximately 6.2. Both a CCD camera (dynamic range approximately 70 dB) and a photodiode (dynamic range approximately 100 dB) were used as detectors. Both the camera and the photodiode were low noise. To minimize mechanical noise, the interferometer was isolated from other parts of the system which could generate mechanical vibration (e.g., valves, pumps). One method of isolating the interferometer is to place it in an enclosure supported by rubber dampers or other types of shock absorbing materials or devices known to those skilled in the art.

The system was calibrated to determine the relation between the phase shift of the beam and the output power of the system. To calibrate the system, a piezo-driven mirror was put on the reference beam. The translation of the mirror modulates the phase of the beam. The smallest detectable translation with the system was 0.1 nm for an integral time of about 10 seconds and 0.45 nm for an integral time of about 1 second.

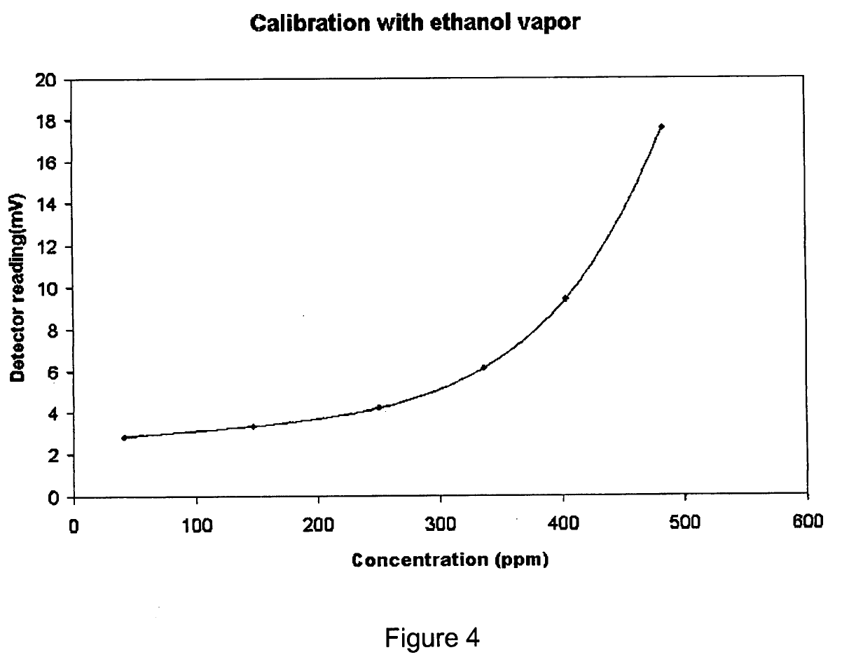

The concentration of the test vapors was also calibrated with the output power of the system using the calibration transducer array described above. FIG. 4 shows the relationship between the detector reading and concentration for ethanol vapor. The smallest ethanol vapor concentration detected with this calibration transducer array was 40 ppm. The smallest water vapor concentration detected with the same array was 41 ppm. The detection limit can also be presented in normalized terms as ppm mm²/sqrt(Hz). An improved sensitivity for water vapor of 8.3 ppm mm²/sqrt(Hz) was obtained by using a transducer of improved surface quality obtained by curing the polymer in a sealed chamber as described above.

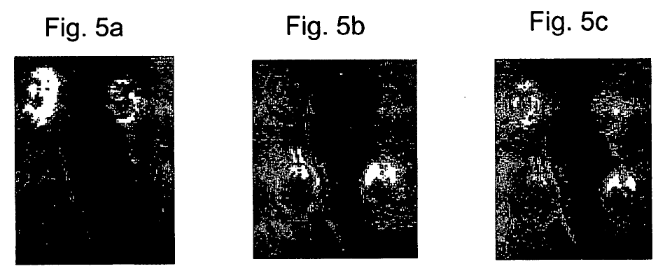

Pattern recognition was tested using the 2 by 2 array described above. FIGS. 5A-5C show the response pattern to ethanol (5A), the response pattern to hexane (5B), and the response pattern to a mixture of ethanol and hexane (5C). In FIGS. 5A-5C, the response of both of the polymers in FIG. 5C is weaker than that in FIG. 5A or FIG. 5B because the concentration of each vapor is lower in the tested mixture.

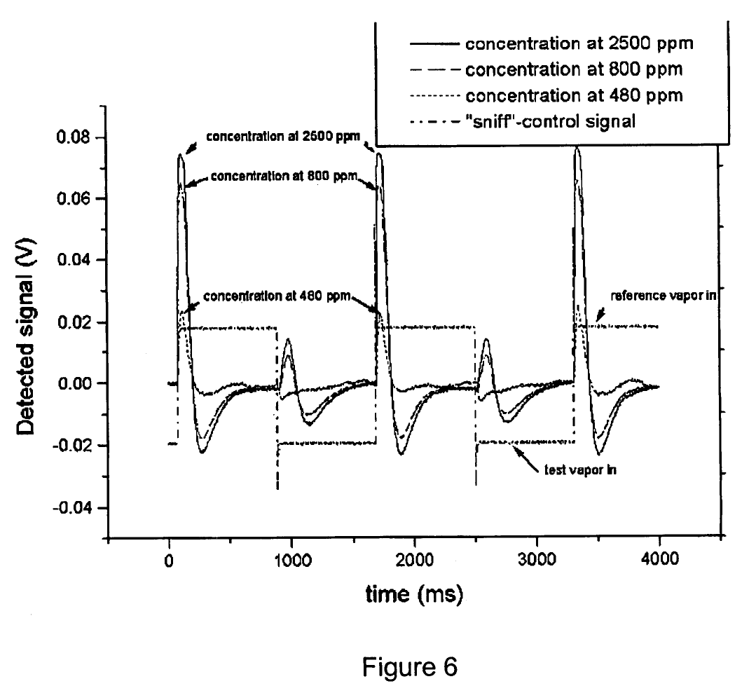

FIG. 6 shows the response of the sensor system to changes in concentration of the vapor environment. In FIG. 6, high voltage levels of the “sniff” control signal represent the phase when the system “sniffs” the reference vapor and low voltage levels represent the phase when the system “sniffs” the test vapor. The peaks at the front edge of the “sniff” control signal are much higher than those at the rear edge. This occurs because the gradient of the vapor concentration is larger when the reference vapor goes into the system. The magnitude of the response drops with a decrease in the vapor concentration.

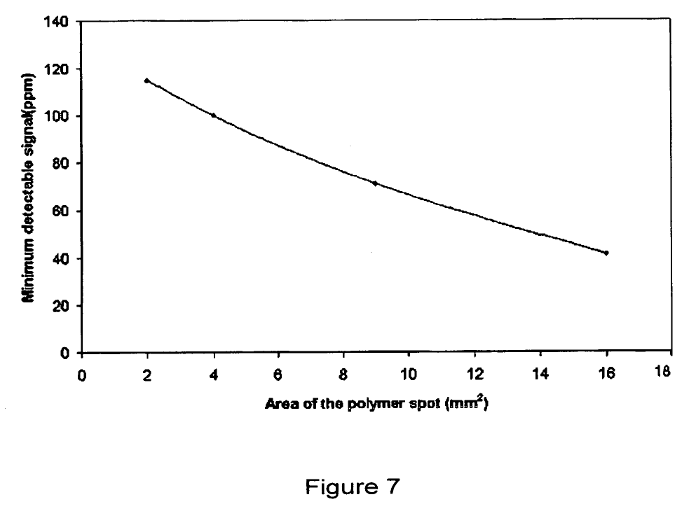

The relationship between the minimum detectable signal and the area of the transducer was investigated. The poly(N-vinylpyrrolidone) transducers were between 10 and 20 microns thick. The transducers were fabricated on glass slides, with each slide having different numbers of transducers. The transducers were fabricated using the manual deposition techniques described above. FIG. 7 shows the relation between the sensitivity and the area of the transducer. From the figure, the relationship appears to be close to linear. The integral time for the measurement was one second.

### EXAMPLE 3

### Two-Beam Coupled Sensor System with Phase Modulation of Reference Beam

The two-beam coupled sensor system of Example 2 was modified by attaching a piezoelectric device to drive mirror (70) thereby phase modulating the reference beam. The modulation signal on the reference beam had an amplitude of 1.3 radian (110 nm) and a frequency of 6.2 Hz. The vapor signal sniff-cycle frequency was approximately 1.4 Hz.

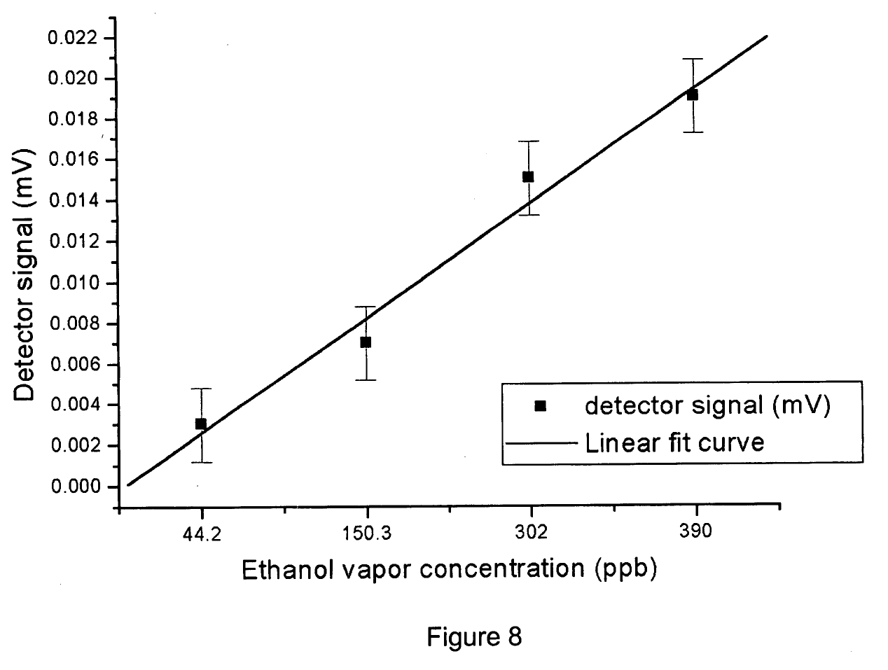

FIG. 8 shows detector signal as a function of ethanol vapor concentration for poly(N-vinyl pyrollidone) transducer array having similar thicknesses and areas to those described in Example 1. The integral time for the measurement was 5 seconds. The detector signal was observed at the sniff -cycle frequency (the detector was synchronized with the sniff-cycle frequency). The normalized sensitivity for ethanol vapor was approximately 60 ppb mm²/sqrt.

Those of ordinary skill in the art will appreciate the existence of equivalents of device elements, method steps, and materials, all known functional equivalents of which are encompassed by the invention. All references cited herein are hereby incorporated by reference to the extent not inconsistent with the disclosure herewith.

1. A method for the detection of a change in concentration of a test vapor in an environment comprising the steps of:
a) providing a transducer capable of absorbing the test vapor and thereby changing the transducer;
b) exposing the transducer to the test vapor; and
c) detecting the change in the transducer using dynamic holography, thereby detecting the change in concentration of the test vapor.

2. The method of claim 1, wherein the change in the transducer is detected by:
a) producing a coherent light source beam;
b) dividing the source beam into an image beam and a reference beam;
c) positioning at least one transducer so that it interacts with the image beam, wherein the transducer is capable of absorbing the test vapor, thereby changing the transducer;
d) after the image beam has interacted with the transducer, combining the image beam and the reference beam, thereby generating an interference pattern;
e) using dynamic holography to produce a hologram based on the interference pattern; and
f) reading out the hologram, thereby detecting the change in concentration of the test vapor.

3. The method of claim 1, wherein the change in the transducer is detected by:
a) producing a coherent light source beam which is a first image beam;
b) positioning at least one transducer so that it interacts with the first image beam, wherein the transducer is capable of absorbing the test vapor, thereby changing the transducer;
c) after the first image beam has interacted with the transducer, dividing the first image beam into a second image beam and a third image beam;
d) combining the second image beam and the third image beam, thereby generating an interference pattern;
e) using dynamic holography to produce a hologram based on the interference pattern; and
f) reading out the hologram, thereby detecting the change in concentration of the test vapor.

4. The method of claim 1, wherein the change in the transducer is detected by:
a) producing a coherent light source beam which is an image beam;
b) positioning at least one transducer so that it interacts with the image beam, wherein the transducer is capable of absorbing the test vapor, thereby changing the transducer;
c) after the image beam has interacted with the transducer, using dynamic holography to generate a hologram within a photorefractive element, the hologram being based on the interaction of the image beam and amplified scattered light from the image beam; and
d) reading out the hologram, thereby detecting the change in concentration of the test vapor.

5. The method of claim 1, comprising creating a hologram within a photorefractive element using dynamic holography.

6. The method of claim 1, comprising digitally creating a hologram using dynamic holography.

7. The method of claim 5, further comprising reading out the hologram, and analyzing the holographic readout at a detector.

8. The method of claim 1, further comprising the step of alternately exposing the test vapor and a reference vapor to the transducer.

9. The method of claim 8, further comprising creating a hologram within a photorefractive element using dynamic holography, reading out the hologram, analyzing the holographic readout at a detector, and synchronizing the detector with the rate at which the test vapor and a reference vapor are alternated.

10. The method of claim 1, wherein the transducer is a polymer film supported on a substrate.

11. The method of claim 1 further comprising exposing a plurality of transducers to the test vapor.

12. The method of claim 1 wherein the change in concentration is detected in less than about 5 seconds.

13. The method of claim 1 wherein the change in concentration is detected in less than about 2 seconds.

14. The method of claim 1 wherein the dimensions of the transducer change when it is exposed to the test vapor.

15. The method of claim 1 wherein the index of refraction of the transducer changes when it is exposed to the test vapor.

16. The method of claim 1 wherein the dimensions and the index of refraction of the transducer change when it is exposed to the test vapor.

17. A method for the detection of a change in concentration of a plurality of test vapors in an environment comprising the steps of:
a) providing a plurality of transducers each capable of absorbing a test vapor and thereby changing the transducer, wherein the transducers are selected so that at least one separate transducer absorbs each of the test vapors;
b) exposing the transducers to the test vapors; and
c) detecting the change in the transducers using dynamic holography, thereby detecting the change in concentration of the test vapors.

18. A method for the determination of the concentration of a test vapor in an environment comprising the steps of:
a) providing a transducer capable of absorbing the test vapor and thereby changing the transducer;
b) alternately delivering the test vapor and a reference vapor to the transducer; and
c) detecting the change in the transducer using dynamic holography when the vapor and the reference vapor are alternated, thereby detecting the concentration of the test vapor.

19. An olfactory sensor system for detecting changes in test vapor concentration in an environment comprising:
a) a coherent light source capable of producing a beam of light;
b) a transducer in optical communication with the light source, in fluid communication with the environment and capable of responding to a change in test vapor concentration;
c) a dynamic holographic medium in optical communication with the transducer; and
d) a detector in optical communication with the dynamic holographic medium, wherein at least part of the beam of light passes from the light source to the transducer, from the transducer to the dynamic holographic medium, and from the dynamic holographic medium to the detector.

20. The sensor system of claim 19 wherein said detector has a sampling rate and further comprising a vapor feeding system capable of alternately delivering the test vapor and a reference vapor to the transducer at a rate of alternation and control equipment capable of synchronizing the sampling rate of the detector with the rate of alternation.

21. The sensor system of claim 20 wherein the control equipment is a lock-in amplifier.

22. The sensor system of claim 19 wherein the detector comprises a CCD camera and a photodiode.

23. The sensor system of claim 19 further comprising analysis equipment in electrical communication with the detector.

24. The sensor system of claim 19 which is portable.

25. The sensor system of claim 19 wherein the transducer is a polymer film.

26. The sensor system of claim 19 comprising a plurality of transducers.

27. The sensor system of claim 26 wherein at least two of the transducers are different in composition.

28. An olfactory sensor system for detecting changes in test vapor concentration in an environment comprising
a) at least one transducer located on a substrate, wherein the transducer is in fluid communication with the environment and capable of responding to a change in test vapor concentration;
b) a vapor feeding system;
c) an interferometer system comprising
i) a coherent light source capable of producing a source beam of light,
ii) a splitter for splitting the source beam into an image beam and a reference beam,
iii) at least one image-beam directing element for directing the image beam to the transducer;
iv) a polarization-modifying element placed in the path of the image beam after it interacts with the transducer;
v) at least one reference-beam directing element for directing the reference beam so that it may be combined with the image beam after the image beam interacts with the transducer;
vi) a polarization control element in the path of the reference beam;
d) a photorefractive element placed so that the image beam and the reference beam interfere within the photorefractive element, the photorefractive element being capable of producing a hologram; and
e) at least one detector in optical communication with the photorefractive element.

29. The sensor system of claim 28 wherein the detector has a sampling rate and the vapor feeding system is capable of alternately delivering a test vapor and a reference vapor to the transducer at a rate of alternation and further comprising control equipment capable of synchronizing the sampling rate of the detector with the rate of alternation.

30. The sensor of claim 29 wherein the control equipment comprises a lock-in amplifier.

31. The sensor of claim 28 further comprising analysis equipment in electrical communication with the detector.

32. The sensor system of claim 28 wherein the detector comprises a CCD camera and a photodiode.

33. The method of claim 2 wherein the reference beam is phase modulated.

34. The sensor of claim 28 further comprising a phase modulator placed in the path of the reference beam after the splitter and before the photorefractive element.
